(19) United States
(12) Patent Application Publication
(10) Pub. No.: US 2015/0222227 A1
(43) Pub. Date: Aug. 6, 2015

(54) MONITORING SYSTEM AND SLAVE DEVICE FOR PHOTOVOLTAIC POWER GENERATION PLANT

(71) Applicants: Hitachi Industry & Control Solutions, Ltd., Ibaraki (JP); National Institute of Advanced Industrial Science and Technology, Tokyo (JP)

(72) Inventors: Sadao Nishizawa, Hitachi (JP); Shintaro Suzumura, Hitachi (JP); Tetsuo Itou, Hitachi (JP); Hideki Yoshida, Hitachi (JP); Yuji Kasai, Tukuba (JP); Masahiro Murakawa, Tukuba (JP)

(73) Assignee: Hitachi Industry & Control Solutions, Ltd., ibaraki (JP)

(21) Appl. No.: 14/424,047

(22) PCT Filed: Feb. 4, 2014
(86) PCT No.: PCT/JP2014/000556

§ 371 Date: Feb. 26, 2015

(30) Foreign Application Priority Data
Feb. 6, 2013 (JP) 2013-021122

(51) Int. Cl. G01R 31/40

(52) U.S. Cl. CPC H02S 50/00

(57) ABSTRACT

A monitoring system includes a slave device (4) and a master device (5). The slave device (4) superposes a current signal, which represents measurement data obtained by measuring each of one or more solar cell panels included in plural solar cell panels (P1 to P15) constituting a solar cell string (10), to a DC current path. The DC current path includes plural power lines (L1 to L14), a first trunk power line (21), and a second trunk power line (22). The master device (5) is connected onto the first trunk power line (21), second trunk power line (22), or both of the trunk power lines, and receives the measurement data from the slave device (4). Accordingly, the communication performance between the slave device and master device in, for example, a monitoring system that performs monitoring in units of a solar cell panel can be improved.

### TECHNICAL FIELD

The present invention relates to a monitoring system for photovoltaic power generation plant. In particular, the present invention is concerned with a slave device that communicates using a direct-current power line over which power produced by solar cell panels is transmitted, and a monitoring system.

### BACKGROUND ART

Typical photovoltaic power generation plant (which may be called a photovoltaic system) includes a solar cell array having plural solar cell panels (which may be called solar cell modules) connected in series and parallel with one another. The solar cell array has solar cell strings, each of which has solar cell panels connected in series with one another, connected in parallel with one another. Direct-current (DC) power produced by the solar cell array is fed to a power conditioner over a DC power line. The power conditioner includes a DC-to-AC inverter that converts the DC power into alternating-current (AC) power.

A system (so-called sensor network) that monitors photovoltaic power generation plant using a sensor such as an ammeter, voltmeter, or wattmeter is known. Such a monitoring system for the photovoltaic power generation plant includes a slave device which transmits measurement data acquired by the sensor, and a master device that receives the measurement data from the slave device. The slave device is disposed to be connected to, for example, solar cell panels (solar cell modules), a solar cell string, or a solar cell array. A power generating situation can be monitored in units of the solar cell string or solar cell array.

Patent documents 1 and 2 disclose monitoring systems each having a slave device disposed for each of solar cell panels for the purpose of performing monitoring in units of the solar cell panel. Further, in the case of a photovoltaic power generation system, a DC power line over which power generated by the solar cell panels is fed to a power conditioner can be utilized as a communication link between the slave device and a master device. The monitoring systems disclosed in the patent documents 1 and 2 use the DC power line as the communication channel over which the slave device and the master device communicate with each other.

For example, in the monitoring system of the patent document 1, the slave device is disposed for each of solar cell panels. The slave device produces a transmission frame in which monitoring information concerning the solar cell panel is encoded, uses a spread code, which is assigned in advance, to directly spread bits of the transmission frame, and thus produces a transmission signal. The slave device transmits the transmission signal as a current signal. In other words, the slave device superposes a current change, which depends on the transmission signal, to the DC power line coupled to the solar cell panel. The master device in the patent document 1 is disposed, for example, near the power conditioner. The master device detects each of the current signals, which are sent from the plural slave devices, as a voltage change between two power lines of high-voltage power and low-voltage power. The communication master device performs inverse spread processing on a detected receiving signal so as to discriminate and receive bit streams transmitted from the respective communication slave devices. Accordingly, the master device monitors a power generating situation of each of the solar cell panels.

### CITATION LIST

### Patent Document

Patent document 1: WO 2011/158681

Patent document 2: EP 2533299

### SUMMARY OF THE INVENTION

### Technical Problem

In order to monitor a power generating situation of photovoltaic power generation plant in detail, the power generating situation is preferably monitored in units of a solar cell panel. Therefore, the monitoring systems disclosed in the patent documents 1 and 2 adopt a configuration having a slave device disposed for each of solar cell panels. However, the present inventor et al. have found that the configuration having the slave device disposed for each of solar cell panels is confronted with a problem that the communication performance between the slave device and master device is degraded. The problem will be described below in conjunction with a comparative example on which the present inventor et al. have discussed.

### Description of the Comparative Example

FIG. 1 shows an example of a configuration of a photovoltaic power generation system in accordance with the comparative example. The photovoltaic power generation system shown in FIG. 1 includes photovoltaic power generation plant and a monitoring system thereof. The photovoltaic power generation plant includes a solar cell string 10, DC power lines 21 and 22, and a power conditioner 3. The solar cell string 10 includes plural solar cell panels (PV) P1 to P15 connected in series with one another over DC power lines L1 to L14. The solar cell string 10 and the power conditioner 3 are connected to each other over the two DC power lines 21 and 22. The DC power line 21 is a power line of high-voltage power, and the DC power line 22 is a power line of low-voltage power. The power conditioner 3 acquires DC power, which is produced by the solar cell string 10, over a DC current path including the DC power lines 21 and 22 and the DC power lines L1 to L14. The power conditioner 3 has the capability of a DC-to-AC inverter, and converts the DC power, which is produced by the solar cell string 10, into AC power.

The monitoring system includes plural slave devices (remote units (RU)) 8 and a master device (base unit (BU)) 9. For performing monitoring in units of a solar cell panel, the slave devices 8 are associated with the solar cell panels (PV) P1 to P15. The slave device 8 transmits measurement data (for example, a current, voltage, temperature, or the like) acquired by a sensor. More particularly, the slave device 8 superposes a current signal (that is, a current signal in which the measurement data is encoded), which represents the measurement data, into the DC current path over which the solar cell string 10 and power conditioner 3 are connected to each other.

The master device 9 communicates with the plural slave devices 8, and receives measurement data from the respective slave devices 8. In the example shown in FIG. 1, the master device 9 is connected onto the DC power line 21 by way of a current transformer (CT) 6.

FIG. 2 is a block diagram showing an example of the configuration of the slave device 8 in accordance with the comparative example. The example of the configuration shown in FIG. 2 is the configuration of the slave device 8 connected to the solar cell panel P1 on the highest potential side in the solar cell string 10. The slave device 8 in FIG. 2 includes a current detection circuit 81, voltage detection circuit 82, controller 83, and transmitter 84. The current detection circuit 81 detects an output current of the solar cell panel P1. The current detection circuit 81 may be implemented using, for example, a Hall element or a resistor offering a microscopic resistance. The voltage detection circuit 82 is connected between the DC power line 21 and DC power line L1, and detects an output voltage of the solar cell panel P1. The voltage detection circuit 82 is connected onto the DC power line 21, and detects a voltage on the DC power line 21 with respect to a reference voltage that is not shown (for example, a voltage on the DC power line L1). The voltage detection circuit 82 may be connected between the DC power line 21 and DC power line L1 in order to detect the output voltage of the solar cell panel P1.

The controller 83 transmits measurement data, which is obtained by each of the current and voltage detection circuits 81 and 82, to the master device 9 via the transmitter 84. Specifically, the controller 83 acquires the measurement data obtained by each of the current and voltage detection circuits 81 and 82, produces a digital transmission signal (transmission bit stream) in which the measurement data is encoded, and feeds the digital transmission signal to the transmitter 84. The controller 83 may be implemented using, for example, a microcontroller (microprocessor) or digital signal processor (DSP).

The transmitter 84 communicates with the master device 9 by employing a power line communication technology. More particularly, the transmitter 84 includes a line driver (line amplifier), and superposes a digital transmission signal as a current signal to each of the DC power lines 21 and L1. The line driver of the transmitter 84 is generally connected onto each of the two DC power lines 21 and L1, which are coupled to the solar cell panel P1, in parallel with the solar cell panel P1.

FIG. 3 shows an equivalent circuit of the photovoltaic power generation system in accordance with the comparative example described in conjunction with FIG. 1 and FIG. 2. FIG. 3 shows only the slave device 8 connected to the solar cell panel P1. The slave device 8 in FIG. 3 is expressed as a current source, and superposes a current signal Itx′, in which measurement data is encoded, to the DC current path. The slave device 8 is connected in parallel with the solar cell panel P1 between the DC power lines 21 and L1. Therefore, the current signal Itx′ of the slave device 8 is bifurcated into a current Ip′ which flows through a closed circuit (loop) including the solar cell panel P1, and a current Ict′ which flows through a closed circuit (loop) including the other solar cell panels P2 to P15 and power conditioner 3. In conformity with a current divider rule, the current Ict′ is expressed as a formula (1) below.

$$\begin{matrix}[ Math . 1 ] & \\ {Ict}^{′} = \frac{Z 1}{Z 1 + Z 2 + Z 3 + … + Z 15 + Zin} {Itx}^{′} & ( 1 )\end{matrix}$$

where Z1, Z2, etc., and Z15 denote impedances of the respective solar cell panels P1 to P15, and Zin denotes an impedance of the power conditioner. As seen from the formula (1), the larger the number of solar cell panels included in the solar cell string 10 is, the smaller the division ratio of the current signal Ict′, which flows through the closed circuit including the solar cell panels P2 to P15 and power conditioner 3, is. Since the master device 9 is disposed on the side of the power conditioner, if the current Ict′ gets smaller, it may invite degradation of communication performance (communication quality) between the slave device 8 and master device 9.

The present invention has been devised based on the foregoing findings obtained by the present inventor et al. Accordingly, an object of the present invention is to improve communication performance between a slave device and a master devise included in a monitoring system that performs monitoring in units of a solar cell panel.

### Solution to Problem

According to a first aspect, there is provided a slave device employed in a monitoring system for photovoltaic power generation plant. Herein, the photovoltaic power generation plant includes a solar cell string, first and second trunk power lines, and inverter. The solar cell string includes plural solar cell panels connected in series with one another over plural power lines. The first trunk power line is coupled to the solar cell panel on the highest voltage side out of the plural solar cell panels. The second trunk power line is coupled to the solar cell panel on the lowest voltage side out of the plural solar cell panels. The inverter acquires DC power, which is produced by the solar cell string, over a DC current path including the plural power lines, the first trunk power line, and the second trunk power line, and converts the DC power into AC power. The slave device in accordance with the present embodiment includes a transmitter that superposes a current signal, which represents measurement data, to the DC current path in order to transmit the measurement data, which is obtained by measuring each of one or more solar cell panels included in the plural solar cell panels, to a remotely disposed master device.

According to a second aspect, a monitoring system includes the slave device in accordance with the first aspect, and a master device that is connected onto the first or second trunk power line or both of the trunk power lines and receives the first measurement data from the first slave device.

According to a third aspect, a photovoltaic power generation system includes the monitoring system in accordance with the second aspect, and the photovoltaic power generation plant connected to the monitoring system.

### Advantageous Effects of the Invention

According to the foregoing aspects, communication performance between a slave device and a master device in a monitoring system that performs monitoring in units of a solar cell panel can be improved.

### BRIEF DESCRIPTION OF DRAWINGS

FIG. 1 is a diagram showing an example of a configuration of a photovoltaic power generation system in accordance with a comparative example;

FIG. 2 is a diagram showing an example of a configuration of a slave device (remote unit) in accordance with the comparative example;

FIG. 3 is a diagram showing an equivalent circuit of the photovoltaic power generation system in accordance with the comparative example;

FIG. 4 is a diagram showing an example of a configuration of a photovoltaic power generation system in accordance with the first embodiment;

FIG. 5 is a diagram showing an example of a configuration of a slave device (remote unit) in accordance with the first embodiment;

FIG. 6 is a diagram showing an example of a configuration of a transmitter in accordance with the first embodiment;

FIG. 7 is a diagram showing an equivalent circuit of the photovoltaic power generation system in accordance with the first embodiment;

FIG. 8 is a diagram showing an example of a configuration of a photovoltaic power generation system in accordance with a second embodiment;

FIG. 9 is a diagram showing an example of a configuration of a photovoltaic power generation system in accordance with a third embodiment;

FIG. 10A is a diagram showing an example of a configuration of a photovoltaic power generation system in accordance with a fourth embodiment; and

FIG. 10B is a diagram showing an example of the configuration of the photovoltaic power generation system in accordance with the fourth embodiment.

### DESCRIPTION OF THE EMBODIMENTS

Referring to the drawings, concrete embodiments will be described below in detail. In the drawings, the same reference signs are assigned to the identical or corresponding elements. For a concise explanation, an iterative description will be omitted unless it is needed.

### First Embodiment

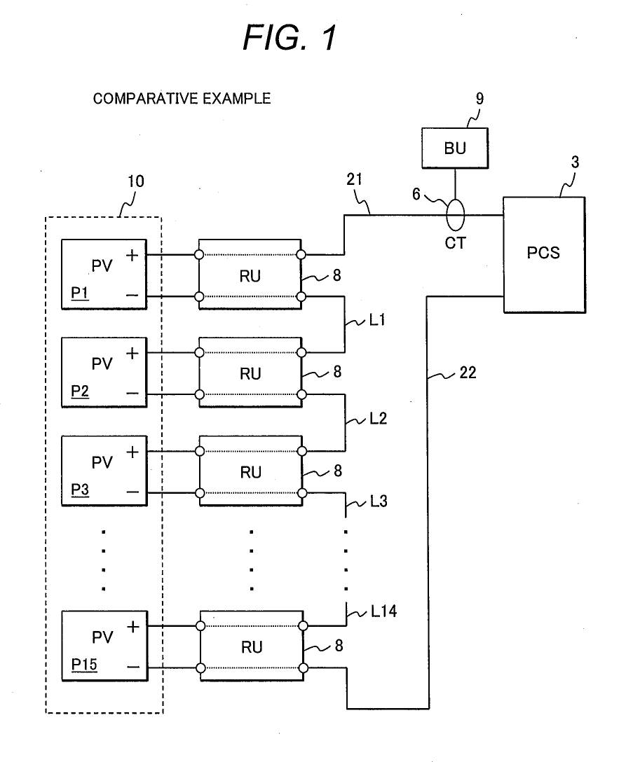

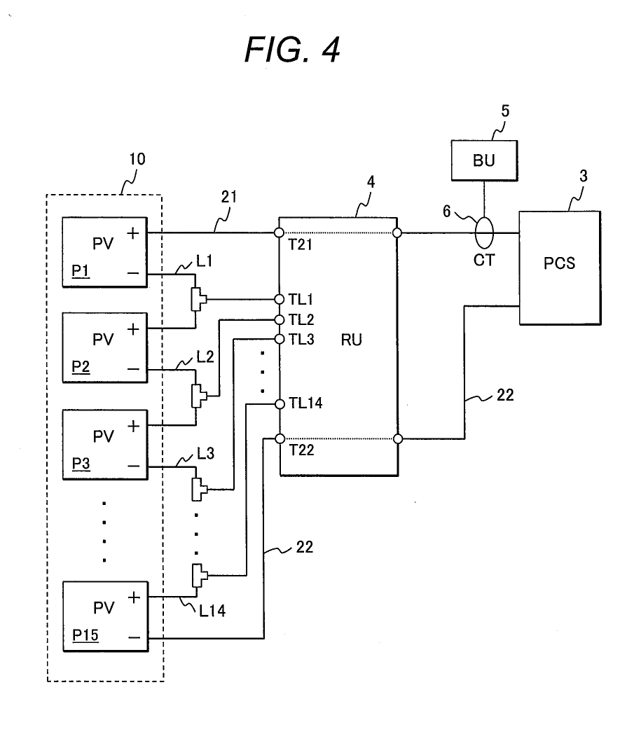

FIG. 4 is a diagram showing an example of a configuration of a photovoltaic power generation system in accordance with the present embodiment. The photovoltaic power generation system shown in FIG. 4 includes photovoltaic power generation plant and a monitoring system thereof. The configuration of the photovoltaic power generation plant shown in FIG. 4 is identical to the one of the comparative example shown in FIG. 1. Specifically, the photovoltaic power generation plant includes a solar cell string 10, DC power lines 21 and 22, and a power conditioner 3. The solar cell string 10 includes plural solar cell panels (PV) P1 to P15 connected in series with one another over DC power lines L1 to L14. The number of solar cell panels included in the solar cell string 10 is arbitrary but is not limited to fifteen shown in FIG. 4.

The solar cell string 10 and power conditioner 3 are connected to each other over the two DC power lines 21 and 22. The DC power line 21 is a power line of high-voltage power, and the DC power line 22 is a power line of low-voltage power. Namely, the DC power line 21 is coupled to the solar cell panel P1 on the highest voltage side out of the solar cell panels P1 to P15 included in the solar cell string 10. In contrast, the DC power line 22 is coupled to the solar cell panel P15 on the lowest voltage side. The power conditioner 3 acquires DC power, which is produced by the solar cell string 10, over a DC current path including the DC power lines 21 and 22 and DC power lines L1 to L14. The power conditioner 3 has the capability of a DC-to-AC inverter and converts the DC power, which is produced by the solar cell string 10, into AC power.

The monitoring system of the present embodiment includes a slave device (remote unit (RU)) 4 and a master device (base unit (BU)) 5. The slave device 4 acquires measurement data (for example, an output voltage), which is obtained by measuring each of the solar cell panels P1 to P15, and superposes a current signal, which represents the measurement data (that is, a current signal in which the measurement data is encoded), to the DC current path (including the DC power lines 21 and 22 and dc power lines L1 to L14) over which the solar cell string 10 and power conditioner 3 are connected to each other. The slave device 4 may include, as shown in FIG. 4, terminals T21, T22, and TL1 to TL14, which are coupled to the dc power lines 21 and 22 and DC power lines L1 to L14 respectively, for the purpose of monitoring the solar cell panels P1 to P15 included in the solar cell string 10.

The master device 5 is connected onto the DC power line 21 or 22 or both of the power lines, and communicates with the slave device 4 so as to receive measurement data from the slave device 4. In the example shown in FIG. 4, the master device 5 is connected onto the DC power line 21 by way of a current transformer (CT) 6. The current transformer 6 feeds an induced current, which is induced in a secondary coil thereof according to a change in a flux which is created in a core with a current flowing through an electric wire (that is, a primary coil) that penetrates through the annular core thereof, to a load resistor, and thus outputs the current as a voltage signal. The master device 5 should merely be connected onto the DC current path over which the solar cell string 10 and power conditioner 3 are connected to each other, and may be connected onto the DC power line 22 via the current transformer 6. A coupling circuit that connects the master device 5 onto the DC power path is not limited to the current transformer 6. For example, the master device 5 may be connected onto each of the DC power lines 21 and 22 in order to detect a voltage change between the DC power lines 21 and 22.

A transmission method employed between the slave device 4 and the master device 5 may be a baseband transmission method that does not use a subcarrier or a carrier modulated transmission method that performs subcarrier modulation. When the baseband transmission is adopted, the slave device 4 produces a transmission signal according to, for example, the non-return-to-zero (NRZ) coding of assigning a transmission bit stream directly to two current levels. When the carrier-modulated transmission is adopted, the slave device 4 maps the transmission bit stream into a transmission symbol stream, and transmits a current signal that represents a current change dependent on the transmission symbol stream. A modulation technique to be employed when the carrier-modulated transmission is adopted is not limited to any specific method, but an arbitrary modulation technique capable of being adopted for power line communication can be adopted. For example, the slave device 4 should merely superpose a change in a current, which represents a carrier wave modulated according to the on-off keying (OOK), amplitude-shift keying (ASk), frequency-shift keying (FSK), or phase-shift keying (PSK), to a DC current flowing through the DC power line.

Further, the master device 5 may communicate with plural slave devices 4 connected to plural solar cell strings 10. In this case, a multiple access method to be employed between the slave devices 4 and the master device 5 is not limited to any specific method but an arbitrary modulation technique capable of being adopted for power line communication can be adopted. For example, the multiple access method that may be adopted in the present embodiment is the spread spectrum multiple access (SSMA), time-division multiple access (TDMA), frequency-division multiple access (FDMA), orthogonal frequency division multiple access (OFDMA), or an arbitrary combination of them.

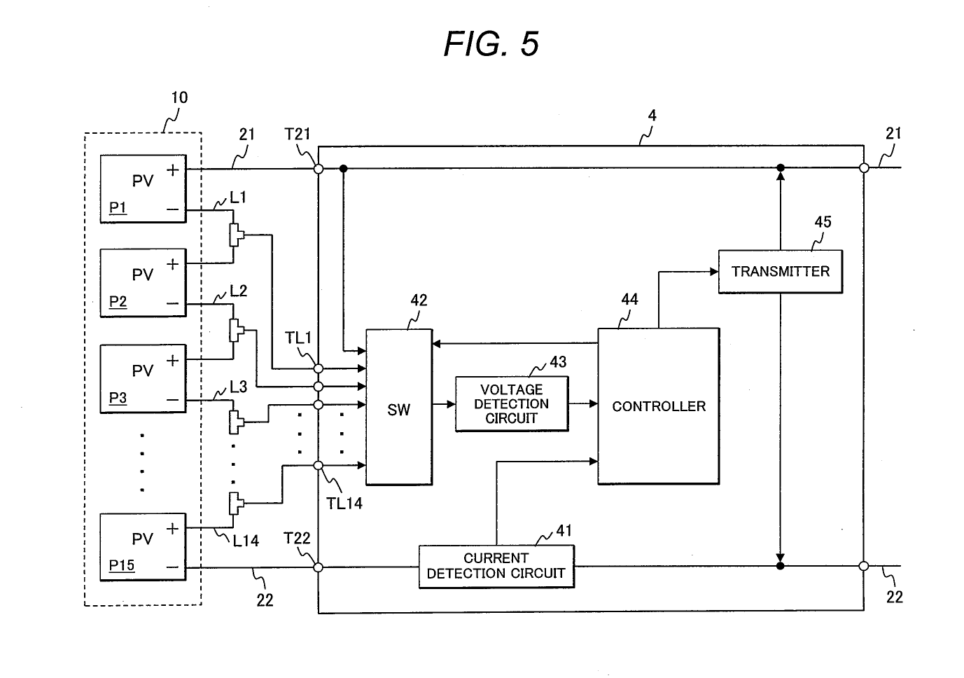

FIG. 5 is a block diagram showing an example of a configuration of the slave device 4 in accordance with the present embodiment. In the example of the configuration shown in FIG. 5, the slave device 4 includes a current detection circuit 41, a switching circuit 42, a voltage detection circuit 43, a controller 44, and a transmitter 45. The current detection circuit 41 is connected onto the DC power line 22 in order to detect an output current of the solar cell panel P15. The current detection circuit 41 may be connected onto the DC power line 21 in order to detect a current flowing through the solar cell panel P1. The current detection circuit 41 may be implemented using a Hall element or a resistor offering a microscopic resistance.

The switching circuit 42 is interposed between the terminals T21, and TL1 to TL14 and the voltage detection circuit 43. The switching circuit 42 switches a connecting destination of the voltage detection circuit 43 among the solar cell panels P1 to P15. The voltage detection circuit 42 detects a voltage at a terminal selected by the switching circuit 42. The voltage detection circuit 42 should merely detect a relative voltage with respect to a reference voltage (for example, a voltage on the DC power line 22) that is not shown. The voltage detection circuit 42 may measure an output voltage of each of the solar cell panels. In this case, the switching circuit 42 may be interposed between the terminals T21 and T22 and T11 to TL14 and the voltage detection circuit 43. The switching circuit 42 sequentially connects a pair of adjoining terminals (for example, a pair of terminals T21 and L1, a pair of terminals TL1 and TL2, or a pair of terminals TL14 and T22) to the voltage detection circuit 43.

The controller 44 transmits measurement data, which is obtained by each of the current and voltage detection circuits 41 and 43, to the master device 9 via the transmitter 45. Specifically, the controller 44 acquires the measurement data obtained by each of the current detection circuit 41 and voltage detection circuit 43, produces a digital transmission signal (transmission bit stream) in which the measurement data is encoded, and feeds the digital transmission signal to the transmitter 45. A data format and transmission frame format to be employed in transmission of the measurement data are not limited to any specific ones. For example, the measurement data concerning the plural solar cell panels P1 to P15 may be transmitted all together using one transmission frame, or may be divided and transmitted using plural transmission frames. The controller 44 may be implemented with a microcontroller (microprocessor) or digital signal processor (DSP).

The transmitter 45 communicates with the master device 5 by employing a power line communication technology. The transmitter 45 includes a line driver (line amplifier), and superposes a digital transmission signal as a current signal to each of the DC power lines 21 and 22. The transmitter 45 is connected in parallel with the solar cell panels P1 to P15 between the DC power lines 21 and 22. More particularly, the transmitter 45 may include the line driver and a coupling circuit that connects the line driver onto each of the DC power lines 21 and 22. The coupling circuit includes, for example, a transformer.

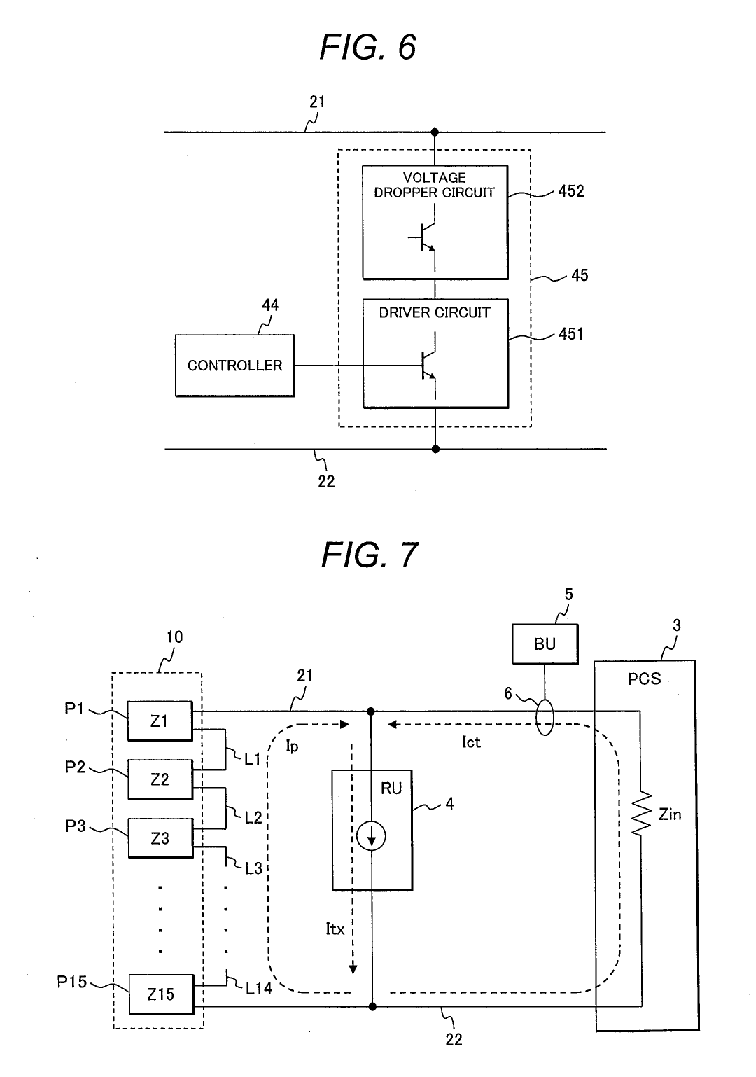

FIG. 6 shows an example of the configuration of the transmitter 45. The transmitter 45 shown in FIG. 6 includes a driver circuit 451 and voltage dropper circuit 452 connected between the DC power lines 21 and 22. The driver circuit 451 is, for example, a constant current circuit using an NPN transistor. In this case, the driver circuit 451 acts to maintain an output current constant according to a voltage signal fed from the controller 44 to a base thereof, and superposes a current change to each of the DC power line 21, onto which the driver circuit is connected via the voltage dropper circuit 452, and the DC power line 22. The voltage signal fed from the controller 44 to the base of the driver circuit 451 is, for example, a pulsating signal and represents a transmission bit stream. The voltage dropper circuit 452 is formed with, for example, a switching element such as a transistor, and drops a high voltage on the DC power lines 21 and 22 to a voltage proper for the driver circuit 451.

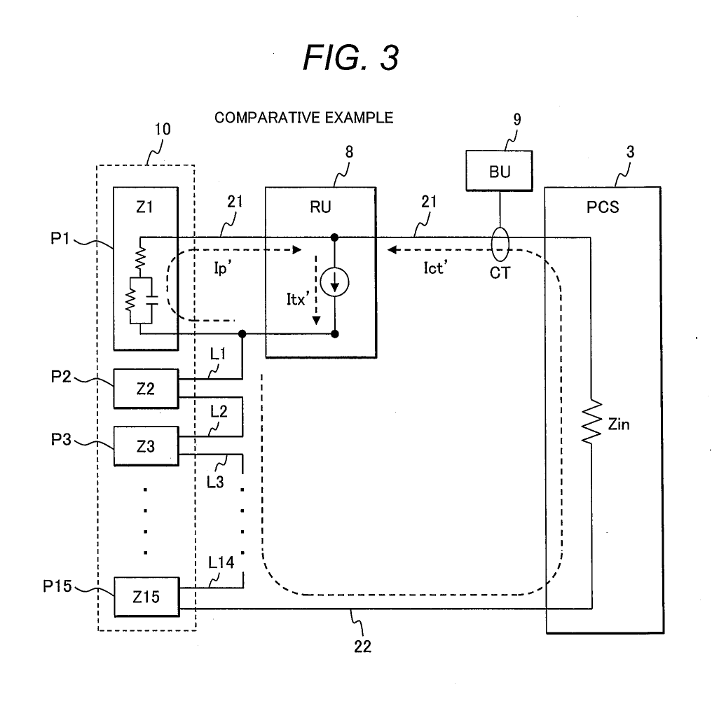

FIG. 7 shows an equivalent circuit of the photovoltaic power generation system in accordance with the present embodiment described in conjunction with FIG. 4 to FIG. 6. The slave device 4 shown in FIG. 7 superposes a current signal Itx, in which measurement data obtained by measuring each of the solar cell panels P1 to P15 is encoded, to the DC current path. The slave device 4 is connected in parallel with the solar cell panels P1 to P15 between the DC power lines 21 and 22. Therefore, the current signal Itx of the slave device 4 is bifurcated into a current Ip that flows through a closed circuit (loop) including the solar cell panels P1 to P15, and a current Ict that flows through a closed circuit (loop) including the power conditioner 3. In conformity with a current divider rule, the current Ict is expressed as a formula (2) below.

$$\begin{matrix}[ Math . 2 ] & \\ Ict = \frac{Z 1 + Z 2 + Z 3 + … + Z 15}{Z 1 + Z 2 + Z 3 + … + Z 15 + Zin} Itx & ( 2 )\end{matrix}$$

where Z1, Z2, etc., and Z15 denote, similarly to those in the formula (1), impedances of the respective solar cell panels P1 to P15. Zin denotes an impedance of the power conditioner. Specifically, in contrast with the comparative example shown in FIG. 3 and relating to the formula (1), the larger the number of solar cell panels included in the solar cell string 10 is, the larger the division ratio of the current signal Ict flowing through the closed circuit including the power conditioner 3 is. The internal impedance Zin of the power conditioner 3 is generally much smaller than the impedance of the solar cell string 10 (that is, the sum of the impedances Z1 to Z15). Therefore, the current signal Itx outputted from the transmitter 45 is thought to almost entirely flow through the closed circuit including the power conditioner 3. Eventually, the communication performance (communication quality) between the slave device 4 and the master device 5 can be upgraded.

As understood from the above description, the slave device 4 of the present embodiment superposes a current signal, which represents measurement data (for example, an output voltage of each panel) obtained by measuring each of the solar cell panels P1 to P15 included in the solar cell string 10, to the DC current path including the DC power lines 21 and 22 and the DC power lines L1 to L14. Further, the slave device 4 includes the transmitter 45 connected in parallel with the solar cell panels P1 to P15, and uses the transmitter 45 to superpose the current signal to the DC current path. Therefore, for performing monitoring in units of a solar cell panel, the slave device 4 of the present embodiment and the monitoring system including the slave device 4 can improve the communication performance between the slave device 4 and the master device 5.

The transmitter 45 of the slave device 4 may not be connected in parallel with all of the solar cell panels P1 to P15, but may be connected in parallel with one or more panels out of the solar cell panels P1 to P15. For example, the transmitter 45 of the slave device 4 may be connected in parallel with the solar cell panels P1 to P14 between the DC power lines 21 and L14. In conformity with a current divider rule, a current signal Ict2 flowing through a closed circuit (loop) including the solar cell panel P15 and power conditioner 3 is expressed as a formula (3) below.

$$\begin{matrix}[ Math . 3 ] & \\ Ict 2 = \frac{Z 1 + Z 2 + Z 3 + … + Z 14}{Z 1 + Z 2 + Z 3 + … + Z 15 + Zin} Itx & ( 3 )\end{matrix}$$

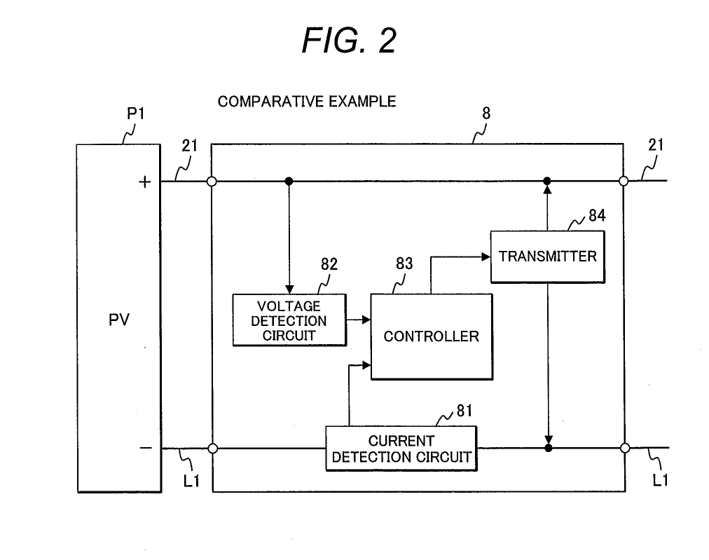

Namely, the division ratio of the current signal Ict2 expressed as the formula (3) is larger than the division ratio of the current signal Ict′ expressed as the formula (1). Therefore, compared with the comparative example described in conjunction with FIG. 1 to FIG. 3, the communication performance between the slave device 4 and the master device 5 can be improved.

In the present embodiment, one slave device 4 acquires measurement data concerning each of the plural solar cell panels, and transmits the data to the master device 5. Therefore, compared with a case where plural slave devices associated with the respective solar cell panels are used as those in the comparative example, the number of slave devices can be reduced. That is to say, the present invention can reduce the number of slave devices in a monitoring system that performs monitoring in units of a solar cell panel.

In the example of the configuration of the slave device 4 shown in FIG. 5, the switching circuit 42 is used to switch the connecting destination of the voltage detection circuit 43 among the solar cell panels P1 to P15. Owing to the configuration, an output voltage of each of the plural solar cell panels can be independently measured using one voltage detection circuit 43.

However, the example of the configuration shown in FIG. 5 is a mere example. For example, the slave device 4 may include plural voltage detection circuits 43. In this case, the switching circuit 42 may be excluded. The slave device 4 may include a sensor (for example, a temperature sensor) other than the current detection circuit 41 and the voltage detection circuit 43.

### Second Embodiment

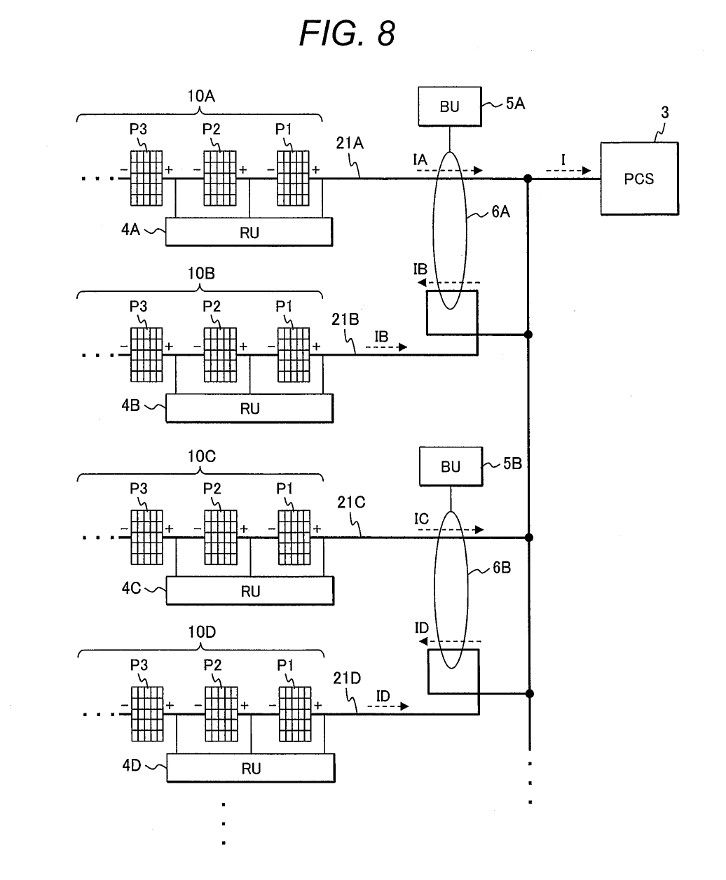

As the present embodiment, a variant of the first embodiment will be described below. FIG. 8 is a block diagram showing an example of a configuration of a photovoltaic power generation system in accordance with the present embodiment. The system shown in FIG. 8 includes plural solar cell strings 10 including solar cell strings 10A to 10D. Each of the solar cell strings 10 includes plural solar cell panels P1, P2, P3, etc. that are connected in series with one another. The plural solar cell strings 10 are connected in parallel with one another over plural DC power lines including DC power lines 21A to 21D. A power conditioner 3 acquires DC powers, which are produced by the respective solar cell strings 10, over the plural DC power lines 21 that are coupled in parallel with one another, and converts the DC powers into AC power.

In FIG. 8, a current IA is a current flowing through the DC power line 21A, that is, a current flowing through the solar cell string 10A. Likewise, currents IB, IC, and ID are a current flowing through the DC power line 21B (that is, the solar cell string 10B), a current flowing through the DC power line 21C (that is, the solar cell string 10C), and a current flowing through the DC power line 21D (that is, the solar cell string 10D) respectively. A current I is a synthetic current of the DC currents flowing through the plural solar cell strings 10 and including the currents IA to ID, and is a DC current to be fed to the power conditioner 3.

FIG. 8 shows only the DC power lines 21 of high-voltage power alone. DC current power lines 22 over which the low-voltage sides of the respective solar cell strings 10 are connected to the power conditioner are not shown in FIG. 8. FIG. 8 shows the four solar cell strings 10A to 10D. The photovoltaic power generation system shown in FIG. 8 may include much more solar cell strings 10 or include only two or three solar cell strings 10.

In the example shown in FIG. 8, a multiple-access communication system including one master device 5 and plural slave devices 4 is used to monitor the states (for example, output voltages, output currents, temperatures, or combination of them) of plural solar cell panels 1. FIG. 8 shows two multiple-access communication systems. One of the multiple-access communication systems includes a master device 5A and plural slave devices 4A and 4B connected to solar cell strings 10A and 10B respectively (power lines 21A and 21B). The other multiple-access communication system includes a master device 5B and plural slave devices 4C and 4D connected to solar cell strings 10C and 10D (power lines 21C and 21D). A multiple access method adopted in the present embodiment is not limited to any specific one but an arbitrary modulation technique capable of being adopted for power line communication can be employed. For example, the multiple access method adopted in the present embodiment may be the SSMA (DS-CDMA), TDMA, FDMA, OFDMA, or an arbitrary combination of them.

The configurations and actions of the slave device 4 and the master device 5 respectively are identical to those described in relation to the first embodiment. In the example of the configuration shown in FIG. 8, similarly to the first embodiment, one slave device 4 is connected to each of solar cell strings 10, and the one slave device 4 monitors plural solar cell panels included in the solar cell string 10. However, in the present embodiment, two or more slave devices 4 may be connected to at least one of the plural solar cell strings 10. Hereinafter, a set of slave devices 4 connected to one solar cell string 10 may be called a slave device (RU) group.

For example, a large-scale photovoltaic power generation system called a mega-solar system uses an enormous number of solar cell panels and an enormous number of solar cell strings. Therefore, a large number of slave devices 4 is needed in order to monitor a large number of solar cell panels. However, a resource (that is, a time, frequency, spread code, or combination of them) to be exclusively employed according to the multiple access method such as the SSMA, TDMA, FDMA, or OFDMA is finite. Accordingly, the number of slave devices 4 that can be connected according to the multiple access method is limited.

In order to cope with the problem of the number of slave devices that can be connected according to the multiple access method, introduction of plural master devices 5 (for example, master devices 5A and 5B) is, as shown in FIG. 8, conceivable. Employment of the plural master devices 5 signifies use of plural multiple-access communication systems. If the same resource can be shared (or reused) among the plural multiple-access communication systems, the aforesaid problem attributable to the upper limit of the number of resources may be solved.

However, the photovoltaic power generation systems like the ones shown in FIG. 8 have a configuration having plural DC power lines 21A to 21D, which are led to the respective solar cell strings 10, coupled in parallel with one another. Therefore, a signal of one of the multiple-access communication systems which includes the master device 5B shown in FIG. 8 interferes with a signal of the other multiple-access communication system, which includes the master device 5A, over the plural DC power lines 21A to 21D coupled in parallel with one another. Therefore, any measure has to be taken in order to share the same resource (that is, a time, frequency, spread code, or combination of them) among the plural multiple-access systems that use the plural power lines 21A to 21D, which are coupled in parallel with one another, for signal transmission.

In order to make it possible to share (or reuse) a resource among plural multiple-access communication systems, the present embodiment has made efforts to insert a power line into an annular core of each of the current transformers (CT) 6A and 6B. The current transformers 6A and 6B in accordance with the present embodiment are concrete examples of a current detection unit that outputs an electric signal representing a change in a difference current between a first current that flows through a first power line, and a second current that flows through a second power line.

The current transformer 6A shown in FIG. 8 produces an electric signal representing a change in a difference current between a current IA flowing through a power line 21A and a current IB flowing through a power line 21B. More particularly, the two power lines 21A and 21B are penetrated through the annular core of the current transformer 6A while being oriented mutually oppositely. Therefore, the DC current IA flowing through the power line 21A from the solar cell string 10A to the power conditioner 3 passes through the annular core of the current transformer 6A from the left in the paper of FIG. 8 to the right. In contrast, the DC current IB flowing through the power line 21B from the solar cell string 10B to the power conditioner 3 passes through the annular core of the current transformer 6A from the right in the paper of FIG. 8 to the left.

When the changes in the DC currents IA and IB are in phase with each other, fluxes induced in the core of the current transformer 6A by the respective currents are opposed to each other and cancel out. When it says that the changes in the currents IA and IB are in phase with each other, it means that both the currents IA and IB increase or decrease, or in other words, that the signs of the time derivatives (that is, slopes) of the currents IA and IB are identical to each other. Supposing the changes in the currents IA and IB are identical to each other, a change in a difference current is not produced. In contrast, when the changes in the DC currents IA and IB are 180° out of phase with each other, fluxes induced in the core by the respective currents are oriented identically and intensified each other. When it says that the changes in the currents IA and IB are 180° out of phase with each other, it means that one of the currents IA and IB increases and the other current decreases, or in other words, that the signs of the time derivatives (that is, slopes) of the currents IA and IB are opposite to each other.

The present embodiment uses the current transformer 6A to produce an electric signal dependent on a change in a difference current between the currents IA and IB, and feeds the electric signal to the master device 5A. Accordingly, the master device 5A receives transmission signals of the two slave devices 4A and 4B (or two slave device groups) connected onto the power lines 21A and 21B respectively, and substantially cancels transmission signals of the other slave devices 4C and 4D (or slave device groups) connected onto the other power lines 21C and 21D respectively. When it says that the master device substantially cancels the transmission signals, it means that the transmission signals of the other slave devices 4C and 4D (or slave device groups) may not be fully canceled to be nullified. In other words, when it says that the master device substantially cancels the transmission signals, it means that the levels of the transmission signals of the slave devices 4C and 4D (or slave device groups) connected onto the power lines 21C and 21D respectively are low enough to receive the transmission signals of the two slave devices 4A and 4D (or two slave device groups), which are connected onto the power lines 21A and 21B respectively, with predetermined quality (for example, predetermined signal-to-noise ratio or bit error rate).

For example, when the slave device 4A (or slave device group) connected onto the DC power line 21A transmits a current signal, the DC current IA changes depending on the current signal. A flow of charge (that is, electrons) attributable to the change in the current IA brings about a reverse-phase change on the other power lines 21 including the power line 21B. For example, if the DC current IA increases due to superposition of the current signal by the slave device 4A, more and more electrons are attracted to the power line 21A. Accordingly, the flow of electrons through the power line 21B (and the other power lines 21C and 21D) reduces. Therefore, a change in the DC current IB (and the currents IC and ID flowing through the other power lines) attributable to an increase or decrease in the DC current IA is 180° out of phase with a change in the current IA. Therefore, the electric signal outputted from the current transformer 6A, that is, the electric signal representing the change in the difference current between the DC currents IA and IB reflects an increase or decrease in the DC current IA. Accordingly, the master device 5A can receive the transmission signal of the slave device 4A, which is connected onto the DC power line 21A, using the electric signal fed from the current transformer 6A.

Transmission from the slave device 4B (or slave device group) connected onto the DC power line 21B can be discussed in the same manner as transmission from the slave device 4A. Specifically, when the slave device 4B places a current signal on the power line 21B, the DC current IB increases or decreases due to superposition of the current signal. A change in the DC current IA (and the currents IC and ID flowing through the other power lines) attributable to the increase or decrease in the DC current IB becomes 180° out of phase with a change in the current IB. Therefore, the master device 5A can receive the transmission signal of the slave device 4B using an output signal of the current transformer 6A representing a change in a difference current between the DC currents IA and IB.

When the DC currents IC and ID flowing through the power lines 21C and 21D respectively increase or decrease due to transmission by the slave devices 4C and 4D (or slave device groups) connected onto the power lines 21C and 21D respectively, the effects are appeared in the DC currents IA and IB, which flow through the power lines 21A and 21B respectively, while being in phase with each other. For example, if the DC current IC on the power line 21C increases due to superposition of a current signal by the slave device 4C, since a large number of electrons is attracted into the power line 21C, flows of electrons through the power lines 21A and 21B respectively decrease. Therefore, changes in the DC currents IA and IB respectively attributable to the increase or decrease in the DC current IC are in phase with each other. Therefore, the changes in the DC currents IA and IB respectively attributable to the increase or decrease in the DC current IC are not appeared in an output signal of the current transformer 6A representing a change in a difference current between the currents IA and IB, but are substantially canceled. Likewise, a current signal to be placed on the power line 21D by the slave device 4D is not appeared in the output signal of the current transformer 6A but is substantially canceled. Accordingly, the master device 5A is unsusceptible to transmission signals sent from the slave devices 4C and 4D respectively, but can receive transmission signals of the respective slave devices 4A and 4B.

As understood from the foregoing description, the two slave devices 4A and 4B (or slave device groups) that utilize the power lines 21A and 21B respectively can share a resource with the other slave devices 4C and 4D that utilize the other power lines 21C and 21D respectively. Interferences by the transmission signals (current signals) sent from the other slave devices 4C and 4D respectively are substantially canceled in a difference current between the DC currents IA and IB.

In communication using the power lines 21, noise generated by equipment relevant to a photovoltaic power generation system, for example, switching noise of the power conditioner 3, and a modulated component derived from an action of the power conditioner 3 following a maximum power operating point are superposed to a current flowing through the power lines 21. Effects of the noise of the power conditioner 3 are appeared in the power lines 21A to 21D, which are coupled in parallel with one another, while being in phase with one another. Therefore, the master device 5A can suppress degradation of receiving quality, which is caused by the noise of the power conditioner 3, by employing an electric signal outputted from the current transformer 6A. This is because the noise of the power conditioner 3 is substantially canceled in a difference current between the DC currents IA and IB.

Likewise, the two power lines 21C and 21D are penetrated through the annular core of the current transformer 6B while being oriented mutually oppositely. Accordingly, the current transformer 6B produces an electric signal representing a change in a difference current between the current IC, which flows through the power line 21C, and the current ID which flows through the power line 21D. Therefore, the master device 5B can receive the transmission signals of the slave devices 4C and 4D respectively while being unsusceptible to the transmission signals of the slave devices 4A and 4B respectively. In addition, the master device 5B can suppress degradation of receiving quality that is caused by the noise of the power conditioner 3.

The arrangement of the current transformers 6A and 6B shown in FIG. 8 is a mere example for detecting a change in a difference current between the currents flowing through the two power lines 2. Another arrangement of the current transformers 6 will be described later in relation to another embodiment.

### Third Embodiment

As the present embodiment, a variant in which the number of power lines 21 penetrated through the core of the current transformer 6 is different from the number of power lines shown in FIG. 8 will be described below. In the second embodiment, the two DC power lines 21 (for example, power lines 21A and 21B) are passed through the core of one current transformer 6 (for example, current transformer 6A) while being oriented mutually oppositely. Accordingly, two DC currents (for example, currents IA and IB) passing through the core of the current transformer 6A are oriented mutually oppositely. However, as understood from the principle of a difference current described in relation to the second embodiment, the number of power lines 21 passed through the core of one current transformer 6 may be an even number of power lines equal to or larger than four. Specifically, among 2N power lines 21 (where N denotes a positive integer), N power lines 21 are passed through the current transformer 6 while being oriented in one direction, and the other N power lines 21 are passed through the core of the current transformer 6 while being oriented in an opposite direction.

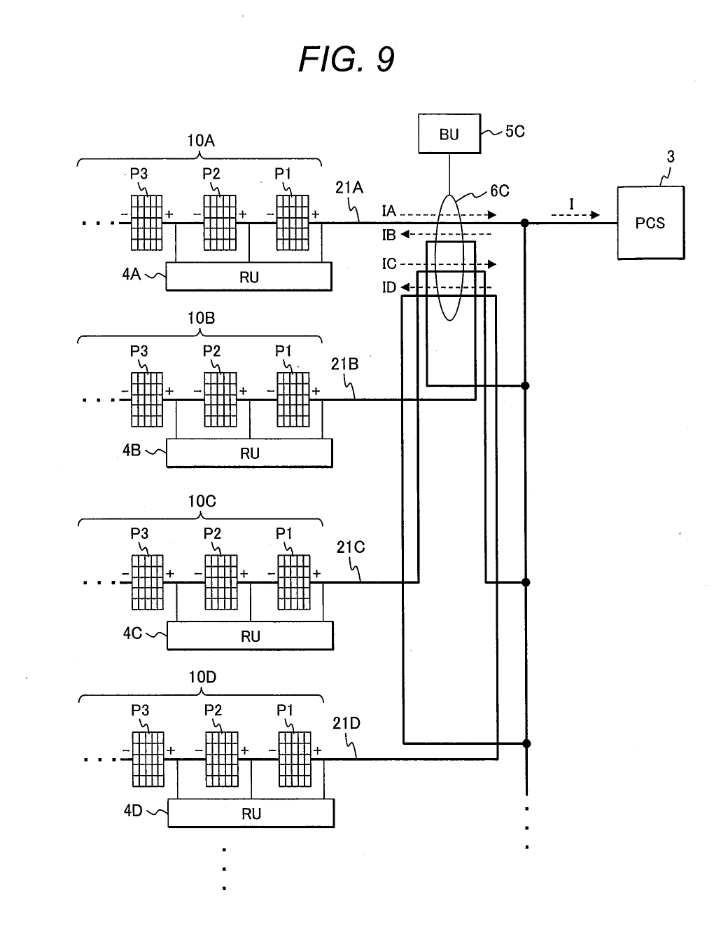

FIG. 9 shows an example in which four power lines 21A to 21D penetrate through the core of one current transformer 6C. More particularly, the power lines 21A and 21C are passed through the annular core of the current transformer 6C from the left in the paper of FIG. 9 to the right. In contrast, the power lines 21B and 21D are passed through the annular core of the current transformer 6C from the right in the paper of FIG. 9 to the left.

The master device 5C in FIG. 9 can communicate with the four slave devices 4A to 4D (or four slave device groups) connected onto the power lines 21A to 21D respectively.

Adoption of the configuration described in relation to the present embodiment provides the advantage that the number of master devices 5 can be decreased. The present embodiment will prove effective particularly in a case where the throughput of the master device 5 or an upper limit of the number of devices that can be connected according to the multiple access method has room for the number of slave devices 4 connected onto one power line 21.

### Fourth Embodiment

In the aforesaid second and third embodiments, in order to detect a change in a difference current between currents flowing through two power lines 21, the two power lines 21 are penetrated through the core of one current transformer 6 while being oriented mutually oppositely. However, this circuitry is a mere example of a current detection unit that detects the change in the difference current between the currents flowing through the two respective power lines 21. As the present embodiment, another example of the circuitry of the current detection unit will be described below.

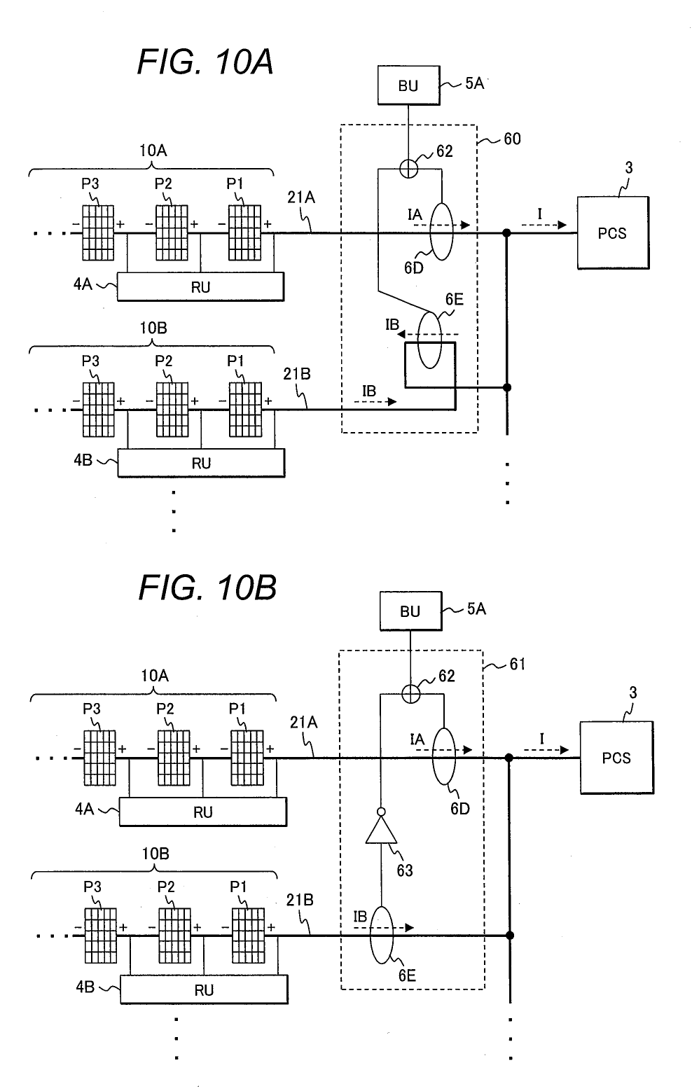

FIG. 10A and FIG. 10B show first and second examples of a configuration of a photovoltaic power generation system in accordance with the present embodiment. As apparent from comparison of FIGS. 10A and 10B with FIG. 8, the examples of the configuration shown in FIGS. 10A and 10B employ current detection units 60 and 61 respectively each including two current transformers 6D and 6E in place of one current transformer 6A. In the current detection unit 60 shown in FIG. 10A, a power line 21A penetrates through the core of the current transformer 6D, and a power line 21B penetrates through the core of the current transformer 6E. However, the orientation in which the power line 21B penetrates through the core of the current transformer 6E is opposite to the orientation in which the power line 21A penetrates through the core of the current transformer 6D. Accordingly, the orientation in which the DC current IA passes through the current transformer 6D is opposite to the orientation in which the DC current IB passes through the current transformer 6E.

An adder 62 in FIG. 10A feeds a signal, which is obtained by adding up the output signals of the current transformers 6D and 6E, to the master device 5A. The signal obtained by adding up the output signals of the current transformers 6D and 6E represents a change in a difference current between the two currents IA and IB flowing through the two power lines 2A and 2B respectively. Therefore, the master device 5A can identify and receive bit streams sent from the two respective slave devices 4A and 4B (or two slave device groups) by employing the output signal of the adder 62.

In the current detection unit 61 shown in FIG. 10B, the DC currents IA and IB pass through the current transformers 6D and 6E respectively while being oriented identically. Therefore, in FIG. 10B, an inverting amplifier 63 is used to invert the output signal of the current transformer 6E. The adder 62 in FIG. 10B adds up the output signal of the current transformer 6D and an inverse signal of the output signal of the current transformer 6E. Accordingly, an output signal of the adder 62 represents a change in a difference current between the two currents IA and IB flowing through the two power lines 21A and 21B respectively. Therefore, the master device 5A can discriminate and receive bit streams, which are sent from the two respective slave devices 4A and 4B (or two slave device groups), using the output signal of the adder 62. As a method in which the inverting amplifier 63 shown in FIG. 10B is not employed, when the output terminals of the current transformers 6D and 6E are connected to the adder 62, they may be connected so that the polarities thereof will be opposite to each other.

When the examples of the configuration of the second and third embodiments (for example, FIG. 8) are compared with the examples (FIG. 10A and FIG. 10B) of the configuration of the present embodiment, the examples of the configuration of the second and third embodiments have the advantage that the number of current transformers can be decreased. The examples of the configuration shown in FIGS. 10A and 10B have a possibility that the receiving quality of the master device 5A may be degraded if the two current transformers 6D and 6E have a property difference. In contrast, the examples of the configuration of the second and third embodiments have the advantage that since a difference current (synthetic current) of currents flowing through plural power lines 21 is detected by one current transformer 6, degradation of the receiving quality of the master device 5 derived from a variance in a property between the current transformers 6 does not occur in principle.

### Other Embodiments

In the second to fourth embodiments, the current transformers 6A to 6E are connected onto the DC power lines 21 of high-voltage power. However, the current transformers 6A to 6E may be connected to the DC power lines 22 of low-voltage power that are not shown in FIGS. 8, 9, 10A, and 10B.

In the aforesaid second to fourth embodiments, an even number of power lines 21 is passed through the core of the current transformer 6. However, an odd number of power lines 21 equal to or larger than three may be passed through the core of the current transformer 6. In a case where the odd number of power lines 21 is passed through the core of the current transformer 6, the number of times by which the power line is passed through the core of the current transformer 6 is varied or a load resistance of the current transformer 6 is designated so that a magnification ratio at which two signals are added up by the adder 62 will be an inverse number of the number of power lines passed through the current transformer 6. For example, when three power lines are passed through the core of the current transformer 6, if two power lines are passed through the annular core while being oriented identically and one power line is passed through the annular core while being oriented oppositely, the oppositely oriented power line is passed through the core twice. Thus, electric signals to be sent from the slave devices 4 connected onto the other power lines can be canceled. The output signal of the adder 62 represents a change in a difference current between the two currents IA and IB flowing through the two power lines 2A and 2B respectively. Therefore, the master device 5A can identify and receive bit streams, which are sent from the two respective slave devices 4A and 4B (or two slave device groups), using the output signal of the adder 62. In the configuration shown in FIG. 10A and described in relation to the fourth embodiment, assuming that an odd number of power lines 21 equal to or larger than three is handled, the load resistance of the current transformer 6 through the annular core of which the power line is passed while being oriented oppositely may be doubled instead of passing the power line through the annular core twice. Accordingly, electric signals that are sent from the slave devices 4 connected onto the other power lines and are inputted to the adder 62 can be canceled.

In the aforesaid second to fourth embodiments, the current transformer is used to detect a change in a difference current between currents flowing through two respective power lines 2. However, in place of the current transformer, any other current detection unit capable of detecting the change in the difference current between the currents flowing through the two respective power lines 21 may be adopted. For example, a current detection unit including a Hall element or shunt resistor may be adopted. When the Hall element or shunt resistor is adopted, an analog differentiating circuit or digital differentiating circuit may be used to observe a change in a difference current, which is derived from current signals of plural slave devices 4, by eliminating an effect of a difference between generated currents of plural solar cell strings 10 (that is, a pure DC component or mean value). The digital differentiating circuit may be integrated into a receiver (for example, signal processing unit) included in the master device 5.

Further, the aforesaid embodiments are mere examples to which a technical idea devised by the present inventor et al. is adapted. In other words, the technical idea is not limited to the aforesaid embodiments but can be modified in various manners.

### REFERENCE SIGNS LIST

P1 to P15: solar cell panel, 21, 21A to 21D, 22, L1 to L14: DC power line, 3: power conditioner (power conditioning system (PCS)), 4: slave device (remote unit (RU)), 5, 5A to 5C: master device (base unit (BU)), 6, 6A to 6E: current transformer (CT), 10, 10A to 10D: solar cell string, 41: current detection circuit, 42: switching circuit, 43: voltage detection circuit, 44: controller, 45: transmitter, 451: driver circuit, 452: voltage dropper circuit, IA: current flowing through the power line 21A, IB: current flowing through the power line 21B, IC: current flowing through the power line 21C, ID: current flowing through the power line 21D, I: current supplied to the power conditioner 3, 60, 61: current detection unit, 62: adder, 63: inverting amplifier.

1. A slave device employed in a monitoring system for photovoltaic power generation plant, the photovoltaic power generation plant comprising:
a first solar cell string having a plurality of first solar cell panels connected in series with one another over a plurality of first power lines;
a first trunk power line coupled to a solar cell panel on the highest voltage side out of the plurality of first solar cell panels;
a second trunk power line coupled to a solar cell panel on the lowest voltage side out of the plurality of first solar cell panels; and
an inverter that acquires DC power, which is produced by the first solar cell string, over a first DC current path including the plurality of first power lines, the first trunk power line, and the second trunk power line, and converts the DC power into AC power, wherein
the slave device includes a transmitter that superposes a first current signal, which represents first measurement data, to the first DC current path to transmit the first measurement data obtained by measuring each of one or more solar cell panels included in the plurality of first solar cell panels, to a remotely disposed master device.

2. The slave device according to claim 1, wherein the transmitter is connected in parallel with the one or more solar cell panels.

3. The slave device according to claim 1, wherein the transmitter is connected between the first trunk power line and the second trunk power line.

4. The slave device according to claim 1, further comprising a sensor that produces the first measurement data, and a switching circuit that switches the connecting destination of the sensor among the one or more solar cell panels.

5. The slave device according to claim 1, wherein the first measurement data includes a measured value of an output voltage obtained by measuring each of the one or more solar cell panels.

6. A monitoring system, comprising:
a first slave device to be implemented with the slave device as set forth in claim 1; and
a master device that is connected onto the first trunk power line, second trunk power line, or both of the trunk power lines, and receives the first measurement data from the first slave device.

7. The monitoring system according to claim 6, the photovoltaic power generation plant further comprising:
a second solar cell string having a plurality of second solar cell panels connected in series with one another over a plurality of second power lines;
a third trunk power line coupled to a solar cell panel on the highest voltage side out of the plurality of second solar cell panels; and
a fourth trunk power line coupled to a solar cell panel on the lowest voltage side out of the plurality of second solar cell panels, wherein the inverter acquires DC power, which is produced by the second solar cell string, over a second DC current path including the plurality of second power lines, the third trunk power line, and the fourth trunk power line, and wherein the monitoring system further comprises a second slave device that convolutes a second current signal, which represents second measurement data obtained by measuring each of one or more solar cell panels included in the plurality of second solar cell panels, to the second DC current path, and
a current detection unit connected onto each of the first trunk power line and third trunk power line, wherein the current detection unit outputs an electric signal that represents (a) a change in a difference current between a current flowing through the first trunk power line and a current flowing through the third trunk power line, or (b) a change in a difference current between a current flowing through the second trunk power line and a current flowing through the fourth trunk power line, and wherein
the master device and the first and second slave devices constitute a multiple-access communication system, and the master device receives the first and second measurement data, which are sent from the first and second slave devices respectively, by processing the electric signal.

8. The monitoring system according to claim 7, wherein the current detection unit includes a current transformer, the first or second trunk power line is penetrated through the annular core of the current transformer, the third or fourth trunk power line is penetrated through the annular core while being oriented oppositely to the first or second trunk power line, and the electric signal is a voltage signal or current signal outputted to the secondary coil of the current transformer.

9. The monitoring system according to claim 7, wherein,
the current detection unit includes first and second current transformers, the first or second trunk power line is penetrated through the annular core of the first current transformer, the third or fourth trunk power line is penetrated through the annular core of the second current transformer, and the electric signal is a signal obtained by adding up output voltages or output currents of the first and second current transformers or subtracting one of the output voltages or output currents from the other.

10. A photovoltaic power generation system comprising:
the monitoring system according to claim 6; and
the photovoltaic power generation plant connected to the monitoring system.
